(19) United States
(12) Patent Application Publication
(10) Pub. No.: US 2012/0255949 A1
(43) Pub. Date: Oct. 11, 2012

(54) MOUNTING DEVICE FOR DRIVING MEMBER

(75) Inventor: MING-CHUN HSU, Tu-Cheng (TW)

(73) Assignee: HON HAI PRECISION INDUSTRY CO., LTD., Tu-Cheng (TW)

(21) Appl. No.: 13/325,134

(22) Filed: Dec. 14, 2011

(30) Foreign Application Priority Data
Apr. 8, 2011 (TW) 100112152

(51) Int. Cl. B65D 51/00; F16M 13/00

(52) U.S. Cl. 220/200; 248/560

(57) ABSTRACT

A mounting device for driving member with low noise is disclosed. The mounting device for driving member includes a mounting case including a first side plate, and a second side plate opposite to the first side plate. A first resilient member is secured to the first side plate, and a second resilient member is secured to the second side plate. A cover is mounted to the mounting case. The cover and the mounting case together define a receiving space for receiving a driving member. The first resilient member is adapted to receive a first portion of the driving member, and the second resilient member is adapted to receive a third portion of the driving member opposite to the first portion. The first resilient member and the second resilient member suspend the driving member within the receiving space.

### BACKGROUND

1. Technical Field

The present disclosure relates to mounting devices, and particularly a mounting device for driving member with low noise.

2. Description of Related Art

A driving member is used for pressuring ink in an ink supplying system of a printer. However, the driving member may make a lot of noise when the driving member is working. Therefore, an improved mounting device for a driving member may be desired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a mounting device and a driving member.

FIG. 2 is an isometric assembled view of the mounting device and the driving member of FIG. 1.

FIG. 3 is a cross-sectional view taken along the line III-III in FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

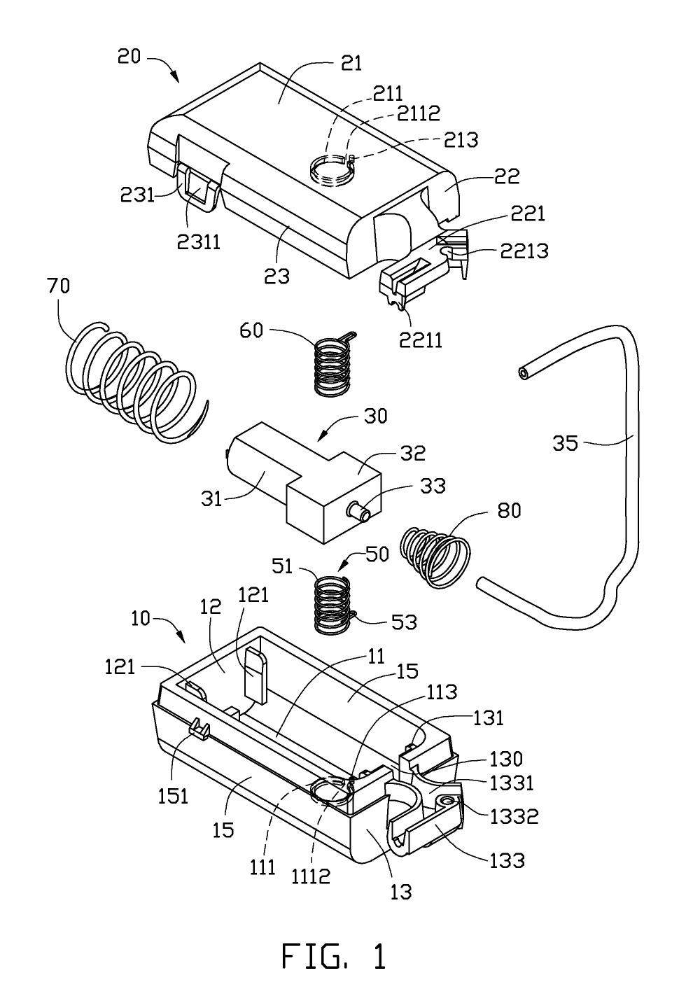

Referring to FIG. 1, a mounting device for a driving member in one embodiment comprises a mounting case 10 and a cover 20.

The mounting case 10 comprises a bottom plate 11, a first side plate 12, a second side plate 13, and two opposite third side plates 15. The first side plate 12 is opposite to the second side plate 13. In one embodiment, the first side plate 12 and the second side plate 13 are substantially perpendicular to the bottom plate 11 and the two third side plates 15. The two third side plates 15 are substantially perpendicular to the bottom plate 11. A first mounting washer 111 and a first mounting post 113 are located on the bottom plate 11. The first mounting washer 111 defines a first cutout 1112 corresponding to the first mounting post 113. Two first limiting pieces 121 extend from an inner surface of the first side plate 12. Two second limiting pieces 131 extend from an inner surface of the second side plate 13. In one embodiment, the two first limiting pieces 121 and the two second limiting pieces 131 are substantially perpendicular to the first side plate 12. The second side plate 13 defines an opening 130 between the two second limiting pieces 131. A first installing portion 133 extends from an outer surface of the second side plate 13. The first installing portion 133 defines an installing slot 1331 and a through hole 1332. The installing slot 1331 communicates with the opening 130. A latching portion 151 extends from an outer surface of each of the two third side plates 15. In one embodiment, the two second limiting pieces 131 are similar to the two first limiting pieces 121.

The cover 20 comprises a top wall 21, a first sidewall 22 and two opposite second sidewalls 23. A second mounting washer 211 and a second mounting post 213 are located on the top wall 21. The second mounting washer 211 defines a second cutout 2112 corresponding to the second mounting post 213. A second installing portion 221 extends from an outer surface of the first sidewall 22. The second installing portion 221 defines a bulge portion 2211 and an installing hole 2213. The bulge portion 2211 can be received in the installing slot 1331. An elastically deformable operating piece 231 extends from each of the two second sidewalls 23. The operating piece 231 defines a latching hole 2311.

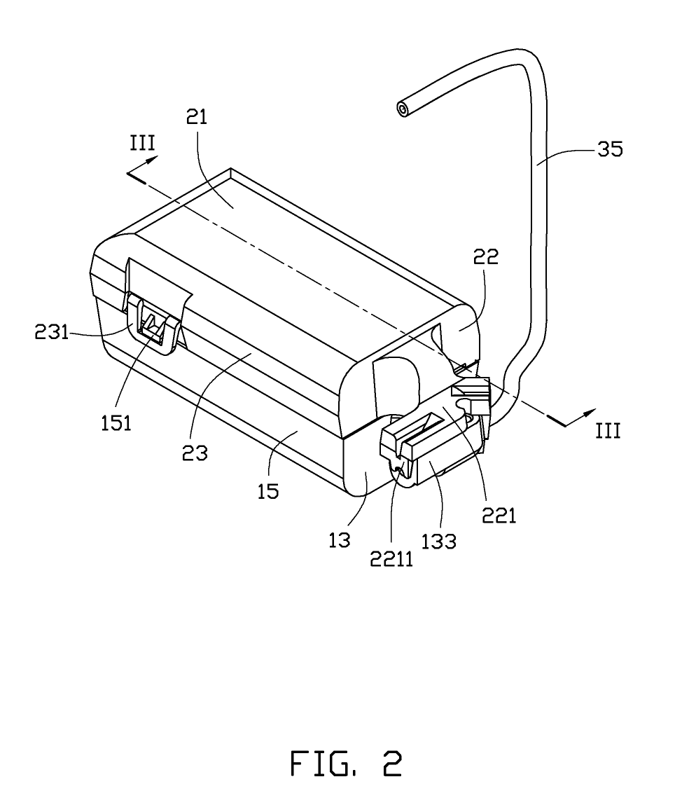

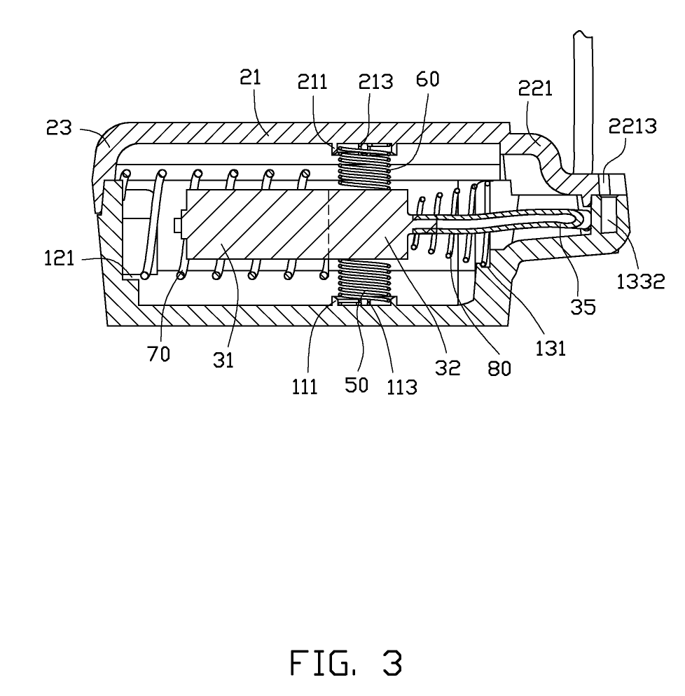

Referring to FIGS. 1-3, a third resilient member 50 is mounted in the mounting case 10. The third resilient member 50 comprises a body 51 and a positioning portion 53 connected to the body 51. The positioning portion 53 engages with the first mounting post 113 and is located in the first cutout 1112. The positioning portion 53 exerts an elastic force to secure itself in the first cutout 1112. The body 51 is received in the first mounting washer 111. In one embodiment, the positioning portion 53 has an “n” shape.

A fourth resilient member 60 is mounted in the cover 20. The fourth resilient member 60 is mounted in the second mounting washer 211 and engages with the second mounting post 213 and the second cutout 2112.

The mounting device is adapted to mount a driving member 30. The driving member 30 comprises a first portion 31, a second portion 32, and a third portion 33. The first portion 31 and the third portion 33 extend from two opposite sides of the second portion 32. The third portion 33 is connected to a windpipe 35. In one embodiment, the driving member 30 is a motor.

In assembly, a first resilient member 70 is placed between the two first limiting pieces 121. A second resilient member 80 is placed between the two second limiting pieces 131. The driving member 30 is moved so as to be adjacent to the first resilient member 70. The first portion 31 is inserted in the first resilient member 70. The third portion 33 is inserted in the second resilient member 80. The first resilient member 70 and the second resilient member 80 press horizontally on the two opposite sides of the second portion 32. The second portion 32 rests vertically on the third resilient member 50 in such manner as to elastically deform the third resilient member 50. An end of the windpipe 35 is received in the installing slot 1331 and is further inserted in the driving member 30 and the second resilient member 80 to engage with the third portion 33. Another end of the windpipe 35 extends out of the mounting case 10 through the installing slot 1331. The cover 20 covers the mounting case 10. The second installing portion 221 is aligned with the first installing portion 133, and the two second sidewalls 23 are aligned to the two third side plates 15. The cover 20 is moved towards the mounting case 10 until the two second sidewalls 23 abut against the two third side plates 15. The fourth resilient member 60 exerts a constant vertical force against the second portion 32 and is elastically deformed. The operating piece 231 aligns with the latching portion 151, and the installing hole 2213 is aligned to the through hole 1332. The operating piece 231 is deforms slightly to allow the latching portion 151 to be received in the latching hole 2311. Then the operating piece 231 responds to engage the latching portion 151 in the latching hole 2311. A locking member (not labeled), such as a screw, is inserted into the installing hole 2213 and the through hole 1332. The cover 20 is thus secured to the mounting case 10. A receiving space is defined by the cover 20 and the mounting case 10. In one embodiment, the receiving space is an airtight space. The driving member 30 is sandwiched between the third resilient member 50 and the fourth resilient member 60. A receiving space is defined by the cover 20 and the mounting case 10.

In use, most of the noise generated by the driving member is isolated by the receiving space. The driving member 30 is suspended in the receiving space by the third resilient member 50, the fourth resilient member 60, the first resilient member 70, and the second resilient member 80. When the driving member 30 is vibrating, the third resilient member 50, the fourth resilient member 60, the first resilient member 70 and the second resilient member 80, or any of them, act to absorb and dampen any such vibration so as to prevent it reaching the cover 20 and the mounting case 10. The same arrangement also protects the driving member 30 from any shocks or jars experienced by the cover 20 or the mounting case 10.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure, to the full extent indicated by the broad general meaning of the terms in which the appended claims are expressed.

What is claimed is:

1. A mounting device comprising:
a mounting case comprising a first side plate, and a second side plate opposite to the first side plate, a first resilient member secured to the first side plate, and a second resilient member secured to the second side plate; and
a cover mounted to the mounting case, and the cover and the mounting case together defining a receiving space for receiving a driving member;
wherein the first resilient member is adapted to receive a first portion of the driving member, and the second resilient member is adapted to receive a third portion of the driving member opposite to the first portion; and the first resilient member and the second resilient member suspend the driving member within the receiving space.

2. The mounting device of claim 1, wherein the mounting case further comprises a bottom plate substantially perpendicular to the first side plate and the second side plate, and the cover comprises a top wall substantially parallel to the bottom plate; a third resilient member is secured to the bottom plate opposite to the top wall, and a fourth resilient member is secured to the top wall and opposite to the bottom plate.

3. The mounting device of claim 2, wherein the first resilient member and the second resilient member abut two side surfaces of a second portion of the driving member, the second portion is located between the first portion and the third portion.

4. The mounting device of claim 3, wherein the third resilient member abuts a bottom surface of the second portion, and the fourth resilient member abuts a top surface of the second portion opposite to the bottom surface.

5. The mounting device of claim 1, wherein the mounting case further comprises two first limiting pieces extending from the first side plate, the first resilient member is secured between the two first limiting pieces, and the two first limiting pieces are substantially perpendicular to the first side plate.

6. The mounting device of claim 1, wherein the mounting case further comprises two second limiting pieces extending from the second side plate, the second resilient member is secured between the two second limiting pieces, and the two second limiting pieces are substantially perpendicular to the second side plate.

7. The mounting device of claim 2, wherein a first mounting washer is located on the bottom plate of the mounting case, the third resilient member comprises a body and a positioning portion, and the body is mounted in the first mounting washer.

8. The mounting device of claim 7, wherein a first mounting post extends from the bottom plate, the first mounting washer defines a first cutout, and the first mounting post is opposite to the first cutout.

9. The mounting device of claim 8, wherein the first mounting post is received in the positioning portion of the third resilient member, and the positioning portion is engaged in the cutout.

10. The mounting device of claim 7, wherein the positioning portion has an “n” shape.

11. A mounting device comprising:
a mounting case comprising a first side plate, a second side plate opposite to the first side plate, and a bottom plate substantially perpendicular to the first and second side plate;
a first resilient member secured to the first side plate, a second resilient member secured to the second side plate, and a third resilient member secured to the bottom plate; and
a cover mounted to the mounting case, and comprising a top wall substantially parallel to the bottom plate, and a fourth resilient member is secured to the top wall; and the cover and the mounting case defining a receiving space for receiving a driving member;
wherein the first resilient member is adapted to receive a first portion of the driving member, and the second resilient member is adapted to receive a third portion of the driving member opposite to the first portion; the first resilient member and the second resilient member abut the driving member along a first direction, and the third resilient member and the fourth resilient member abut the driving member along a second direction substantially perpendicular to the first direction.

12. The mounting device of claim 11, wherein the first resilient member, the second resilient member, the third resilient member, and the fourth resilient member suspend the driving member within the receiving space.

13. The mounting device of claim 11, wherein the first resilient member and the second resilient member abut two side surfaces of a second portion of the driving member, the second portion is located between the first portion and the third portion.

14. The mounting device of claim 13, wherein the third resilient member abuts a bottom surface of the second portion, and the fourth resilient member abuts a top surface of the second portion opposite to the bottom surface.

15. The mounting device of claim 11, wherein the mounting case further comprises two first limiting pieces extending from the first side plate, the first resilient member is secured between the two first limiting pieces, and the two first limiting pieces are substantially perpendicular to the first side plate.

16. The mounting device of claim 11, wherein the mounting case further comprises two second limiting pieces extending from the second side plate, the second resilient member is secured between the two second limiting pieces, and the two second limiting pieces are substantially perpendicular to the second side plate.

17. The mounting device of claim 11, wherein a first mounting washer is located on the bottom plate of the mounting case, the third resilient member comprises a body and a positioning portion, and the body is mounted in the first mounting washer.

18. The mounting device of claim 17, wherein a first mounting post extends from the bottom plate, the first mounting washer defines a first cutout, and the first mounting post is opposite to the first cutout.

19. The mounting device of claim 18, wherein the first mounting post is received in the positioning portion of the third resilient member, and the positioning portion is engaged in the cutout.

20. The mounting device of claim 17, wherein the positioning portion has an “n” shape.
